(19) United States
(12) Patent Application Publication
(10) Pub. No.: US 2004/0189723 A1
(43) Pub. Date: Sep. 30, 2004

(54) Testing method for a display apparatus

(76) Inventor: I-Po Yu, Chung-Ho City (TW)

Correspondence Address: NAIPO (NORTH AMERICA INTERNATIONAL PATENT OFFICE), P.O. BOX 506, MERRIFIELD, VA, 22116, US

(21) Appl. No.: 10/461,468

(22) Filed: Jun. 16, 2003

(30) Foreign Application Priority Data
Mar. 27, 2003 (TW) 092107000

(51) Int. Cl. G09G 5/00

(52) U.S. Cl. 345/904

(57) ABSTRACT

A method for testing images displayed on a screen by a display apparatus includes installing a plurality of image capturing devices on the screen, electrically connecting a computer to the image capturing devices, capturing the images on the screen by utilizing the image capturing devices, sending the images captured by the image capturing devices to the computer through the image capturing devices, and processing the images captured by the image capturing devices by utilizing the computer.

### BACKGROUND OF INVENTION

1. Field of the Invention

The present invention relates to a testing method for a display apparatus, especially a testing method to display testing images on a screen and send the testing images captured by image capturing devices to a computer to allow the computer to analyze and process the testing images.

2. Description of the Prior Art

The principle of projectors is very similar to the principle of slides and filmslides. In their operation, a bulb having high brightness is used as a light source to project images to white screens or walls. Since a projector can be connected to a television or a computer terminal to project images on the screen of the television or the computer terminal to a white screen or a wall, users are able to enjoy large-sized frames, which can not be provided by a common television and a common computer terminal, with a projector. Therefore, projectors are very frequently used in a large meeting or a home theater. A projector is regarded as a high potential product in the consumer market because projectors are portable, small-sized, and cheap.

Since projectors enlarge images, any small defects of the images, after being projected to white screens or walls, are presented as abnormalities, such as an image shift phenomenon, an image blurring phenomenon, a dark corner phenomenon, and a color distortion phenomenon. In order to ensure the quality of projectors, various methods are utilized to test and calibrate the projectors during the manufacturing processes of the projectors. According to the prior art, the above-mentioned testing and calibration are performed by the naked eye or a sensing apparatus similiar to a digital camera. However, the errors incurred from different perception of human eyes and visual sensation fatigue result in disputation and poor testing efficiency. Moreover, lenses of the sensing apparatus, similar to a digital camera, contributes errors to sensing images and reduces a reference value of the sensing apparatus.

### SUMMARY OF INVENTION

It is therefore a primary objective of the claimed invention to disclose a testing method for a display apparatus, especially a testing method to display testing images on a screen and send the testing images captured by image capturing devices installed on the screen to a computer to allow the computer to analyze and process the testing images so as to resolve the above-mentioned problems.

According to the claimed invention, the method for testing images displayed on a screen by a display apparatus comprises: installing a plurality of image capturing devices on the screen, electrically connecting a computer to the image capturing devices, capturing the images on the screen by utilizing the image capturing devices, sending the images captured by the image capturing devices to the computer through the image capturing devices, and processing the images captured by the image capturing devices by utilizing the computer.

The claimed invention testing method for the display apparatus includes displaying testing images on the display screen and sending the testing images captured by the image capturing devices installed on the screen to the computer to allow the computer to analyze and process. By utilizing the claimed invention testing method for the display apparatus, the phenomena of image shift, image blurring, dark corner, and color distortion are thus eliminated. The errors incurred from the naked eye or an apparatus similiar to a digital camera, which are frequently used in the prior art testing method for the display apparatus, are decreased. The working load of inspector is reduced to speed up the testing.

This and other objectives of the claimed invention will no doubt become clear to those of ordinary skill in the art after reading the following detailed description of the preferred embodiment, which is illustrated in the various figures and drawings.

### BRIEF DESCRIPTION OF DRAWINGS

FIG. 1 is a schematic diagram of a testing apparatus for a display apparatus according to a first preferred embodiment of the present invention.

FIG. 2 is a schematic diagram of a testing apparatus for a display apparatus according to a second preferred embodiment of the present invention.

FIG. 3 is a schematic diagram of image capturing of a testing apparatus for a display apparatus according to the second preferred embodiment of the present invention.

FIG. 4 is a schematic diagram of a testing apparatus for a display apparatus according to a third preferred embodiment of the present invention.

FIG. 5 is a schematic diagram of image capturing of a testing apparatus for a display apparatus according to the third preferred embodiment of the present invention.

FIG. 6 is a flow chart of a testing method for a display apparatus according to the present invention.

### DETAILED DESCRIPTION

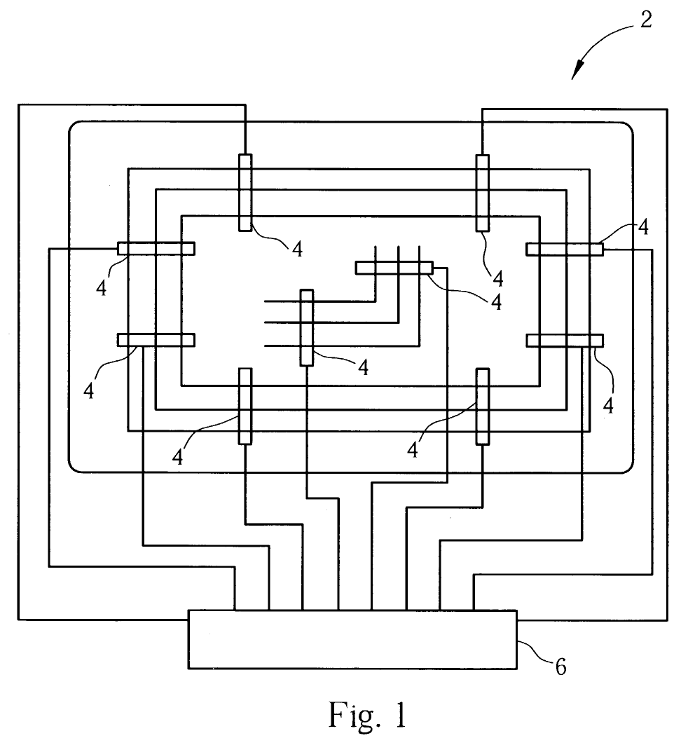

Please refer to FIG. 1. FIG. 1 is a schematic diagram of a testing apparatus 2 for a display apparatus according to a first preferred embodiment of the present invention. As shown in FIG. 1, the testing apparatus 2 for the display apparatus comprises a plurality of image capturing devices 4 and a processing device 6 for testing images electrically connected to the plurality of image capturing devices 4. The plurality of image capturing devices 4, installed on a screen, are used for capturing testing images on the screen. The processing device 6 for testing images is used for analyzing and processing image data captured by the plurality of image capturing devices 4 to calibrate the display apparatus according to the processing results.

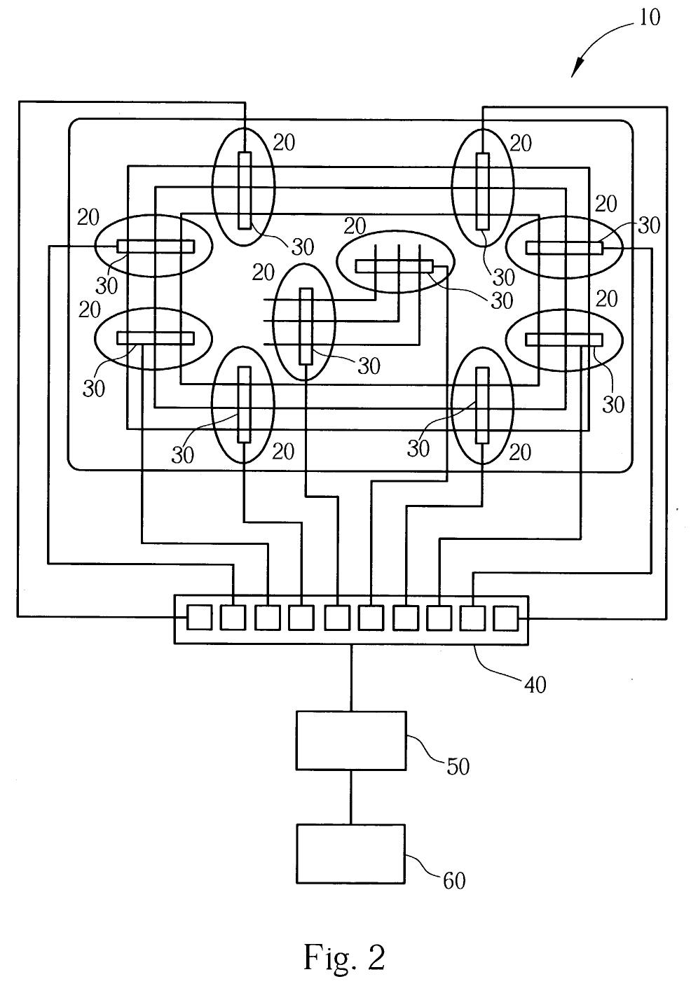

Please refer to FIG. 2. FIG. 2 is a schematic diagram of a testing apparatus 10 for a display apparatus according to a second preferred embodiment of the present invention. As shown in FIG. 2, the testing apparatus 10 for the display apparatus comprises a plurality of color filters 20 and a plurality of image capturing devices 30. Each of the color filters 20 is installed above each of the image capturing devices 30. A multitasking device 40 is electrically connected to the plurality of image capturing devices 30. A converting/transmitting interface for the image capturing device controlling signals 50 is electrically connected to the multitasking device 40. A computer 60 is electrically connected to the converting/transmitting interface for the image capturing device controlling signals 50. The color filters 20 are used for reducing the intensity of light incident from the testing image so that the light intensity is within the acceptable range of the image capturing devices 30. The plurality of image capturing devices 30 installed on the screen are used for capturing the testing images displayed on the screen and transmitting the testing images to the converting/transmitting interface for the image capturing device controlling signals 50 through the multitasking device 40. The multitasking device 40 is used for selecting the required image capturing devices 30. The converting/transmitting interface for the image capturing device controlling signals 50 is used for converting the testing images captured by the image capturing devices 30 into the data having a format ready to be processed by the computer 60. The computer 60 is used for analyzing and processing the image data processed by the converting/transmitting interface for the image capturing device controlling signals 50.

The display apparatus may be a projector and the screen may be a projecting screen. In this case, the images captured by the image capturing devices 30 are generated by projecting images on the projecting screen with the projector. However, the testing apparatus 10 for the display apparatus of the present invention may be applied to other display apparatuses.

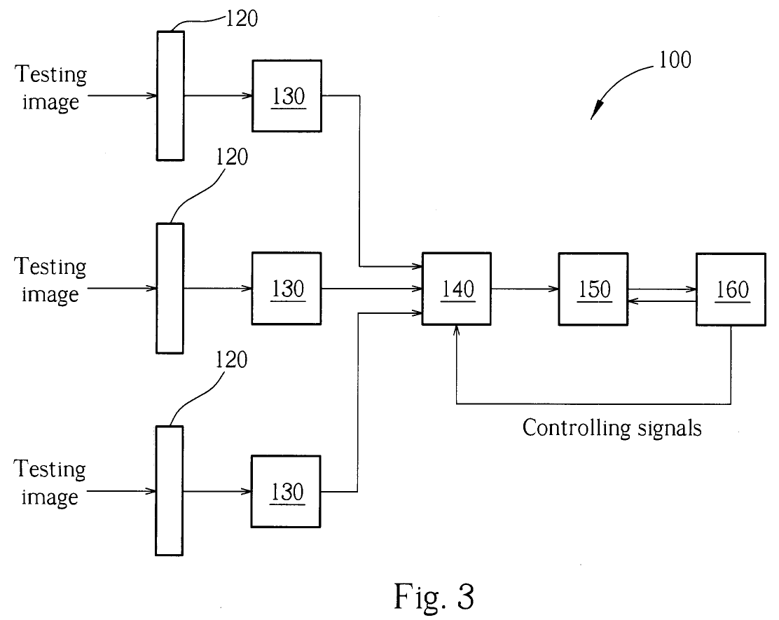

Please refer to FIG. 3. FIG. 3 is a schematic diagram of image capturing of a testing apparatus 100 for a display apparatus according to the second preferred embodiment of the present invention. Each of the components in FIG. 3 corresponds to each of the components in FIG. 2. As shown in FIG. 3, the testing apparatus 100 for the display apparatus utilizes the computer 160 to generate an initialization signal to initialize the converting/transmitting interface for the image capturing device controlling signals 150, and utilizes the computer 160 to generate a plurality of controlling signals to control the multitasking device 140 switching to the image capturing devices 130 in the area to be captured. The testing images captured by the selected image capturing devices 130 are transmitted through the multitasking device 140, processed by the converting/transmitting interface for the image capturing device controlling signals 150, transmitted to the computer 160, and preliminarily analyzed and processed by the computer 160. The above-mentioned steps are repeated until all of the image data for the testing images, captured by the image capturing devices 130 in all of the areas needing to be judged, are analyzed and processed. Finally, the image data for all of the testing images are analyzed and processed to allow the computer 160 to calibrate the display apparatus according to the final results.

The image capturing devices 30 in FIG. 2 and the image capturing devices 130 in FIG. 3 usually comprise charge coupled devices (CCD) or complementary metal-oxide semiconductor transistors (CMOS transistors). However, the image capturing devices according to the present invention may comprise other devices being able to achieve the same objective, and are not limited to these devices.

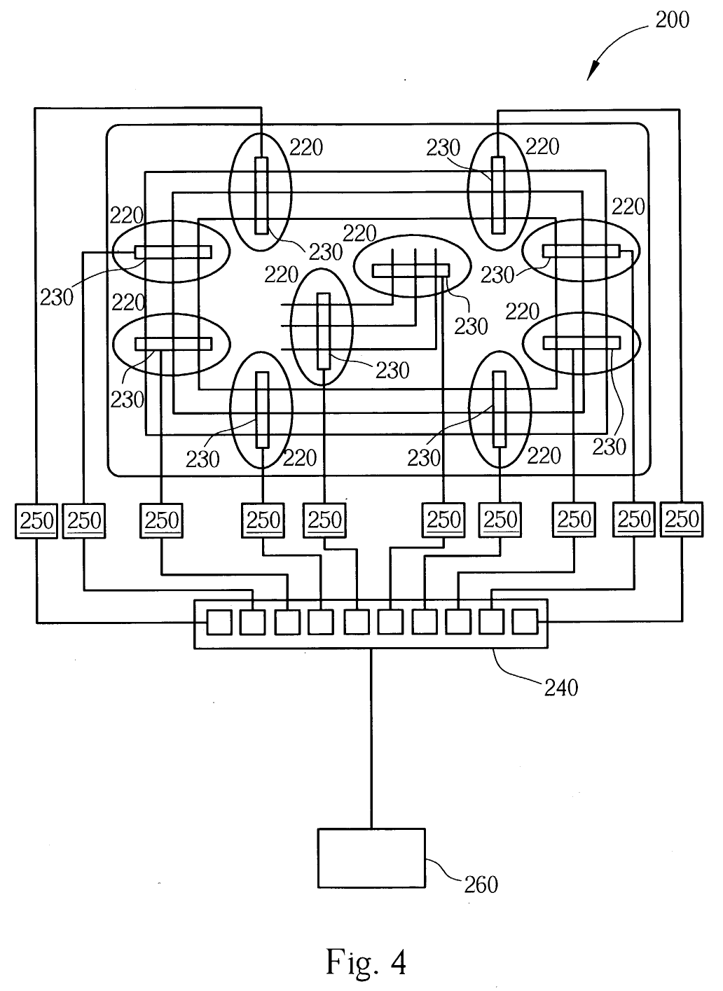

Please refer to FIG. 4. FIG. 4 is a schematic diagram of a testing apparatus 200 for a display apparatus according to a third preferred embodiment of the present invention. As shown in FIG. 4, the testing apparatus 200 for the display apparatus comprises a plurality of color filters 220 and a plurality of image capturing devices 230. Each of the color filters 220 is installed above each of the image capturing devices 230. A plurality of converting/transmitting interfaces for the image capturing device controlling signals 250 are respectively electrically connected to the image capturing devices 230. A multitasking device 240 is electrically connected to the plurality of converting/transmitting interfaces for the image capturing device controlling signals 250. A computer 260 is electrically connected to the multitasking device 240. The color filters 220 are used for reducing the intensity of light incident from the testing image so that the light intensity is within the acceptable range of the image capturing devices 230. The plurality of image capturing devices 230 installed on the screen are used for capturing the testing images displayed on the screen and transmitting the testing images to the converting/transmitting interfaces for the image capturing device controlling signals 250. The multitasking device 240 is used for selecting the required image capturing devices 230. The converting/transmitting interfaces for the image capturing device controlling signals 250 are used for converting the testing images captured by the image capturing devices 230 into the data having a format ready to be processed by the computer 260. The computer 260 is used for analyzing and processing the image data processed by the converting/transmitting interfaces for the image capturing device controlling signals 250.

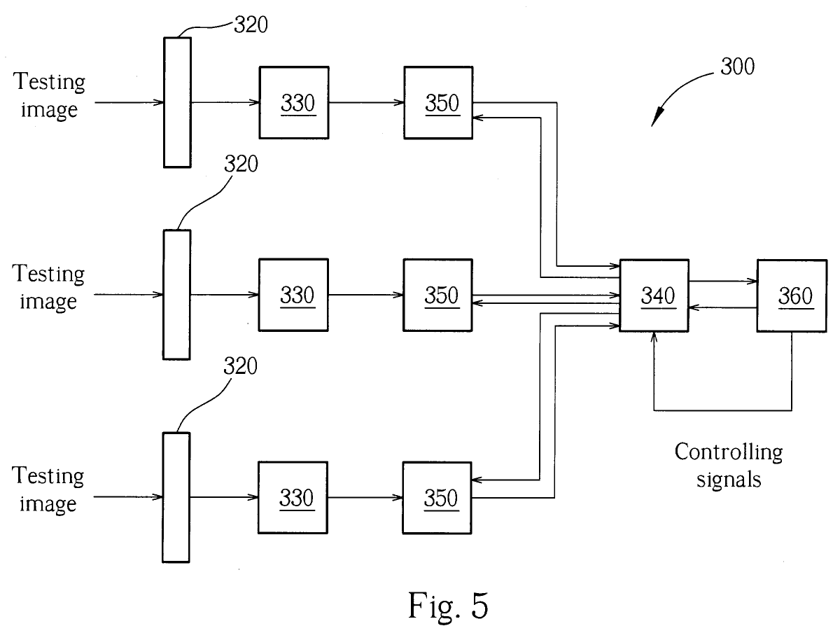

Please refer to FIG. 5. FIG. 5 is a schematic diagram of image capturing of a testing apparatus 300 for a display apparatus according to the third preferred embodiment of the present invention. Each of the components in FIG. 5 corresponds to each of the components in FIG. 4. As shown in FIG. 5, the testing apparatus 300 for the display apparatus utilizes the computer 360 to generate an initialization signal to initialize the converting/transmitting interfaces for the image capturing device controlling signals 350 and transmits the testing images captured by the image capturing devices 330 to the converting/transmitting interfaces for the image capturing device controlling signals 350 for further processing. The testing apparatus 300 for the display apparatus also utilizes the computer 360 to generate a plurality of controlling signals to control the multitasking device 340 switching to the converting/transmitting interfaces for the image capturing device controlling signals 350 in the area to be captured. The testing images captured by the selected image capturing devices 330 and processed by the converting/transmitting interfaces for the image capturing device controlling signals 350 are transmitted to the computer 360 through the multitasking device 340 for preliminary analysis. The above-mentioned steps are repeated until all of the image data for the testing images, captured by the image capturing devices 330 in all of the areas needing to be judged, are analyzed and processed. Finally, the image data for all of the testing images are analyzed and processed to allow the computer 360 to calibrate the display apparatus according to the final results.

The image capturing devices 230 in FIG. 4 and the image capturing devices 330 in FIG. 5 usually comprise charge coupled devices. However, the image capturing devices according to the present invention may comprise other devices being able to achieve the same objective, and are not limited to charge coupled device.

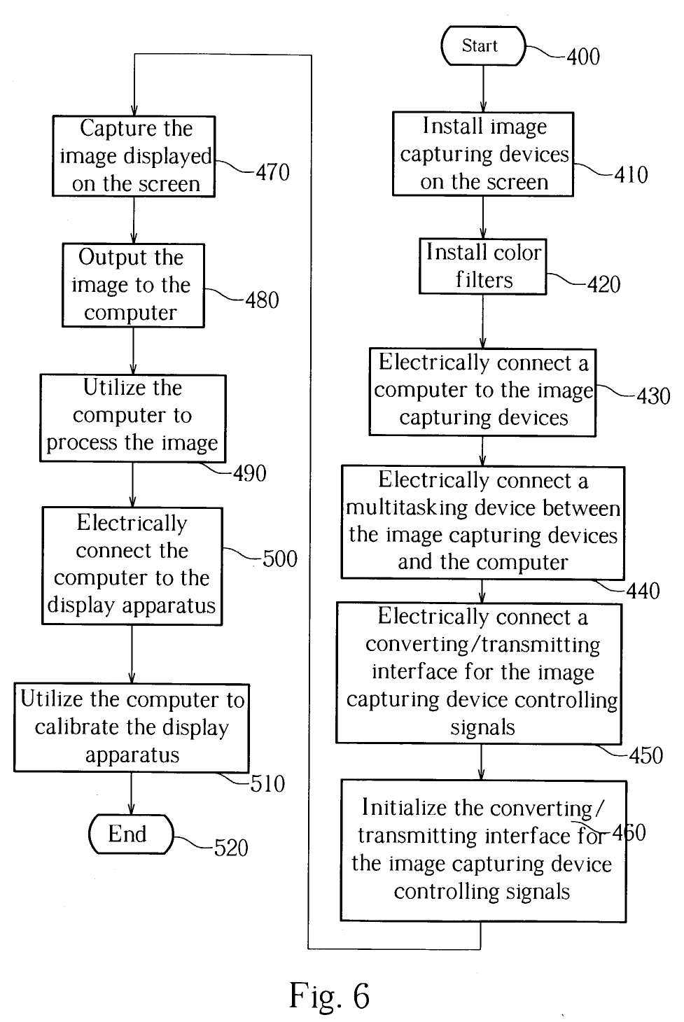

Please refer to FIG. 6. FIG. 6 is a flow chart of a testing method for a display apparatus according to the present invention. The testing method for the display apparatus shown in FIG. 6 can be applied to the above-mentioned testing apparatuses 2, 10, 100, 200, 300 for the display apparatus. The testing method comprise:

Step 400: start;

Step 410: install a plurality of image capturing devices on a screen;

Step 420: install a color filter between the image and each of the image capturing devices to allow the image capturing device to capture the image through the color filter;

Step 430: electrically connect a computer to the image capturing devices;

Step 440: electrically connect a multitasking device between the image capturing devices and the computer;

Step 450: electrically connect a converting/transmitting interface for the image capturing device controlling signals between the computer and the multitasking device, as shown in FIG. 2 and FIG. 3; or electrically connect a plurality of converting/transmitting interfaces for the image capturing device controlling signals between the multitasking device and the image capturing devices respectively, as shown in FIG. 4 and FIG. 5;

Step 460: utilize the computer to generate a plurality of controlling signals to initialize the converting/transmitting interface for the image capturing device controlling signals;

Step 470: utilize the image capturing devices to capture the image displayed on the screen;

Step 480: output the image captured by the image capturing devices to the computer through the image capturing devices, the multitasking device, and the converting/transmitting interface for the image capturing device controlling signals in sequence;

Step 490: utilize the computer to process the image captured by the image capturing devices;

Step 500: electrically connect the computer to the display apparatus;

Step 510: utilize the computer to calibrate the display apparatus according to the images captured by the image capturing devices. For example, if the display apparatus is a projector, calibrate the alignment of the images projected by the projector to improve an image shift phenomenon, calibrate the focusing of the images projected by the projector to improve an image blurring phenomenon, calibrate the brightness of some area of the images projected by the projector to improve a dark corner phenomenon, calibrate the color blending of the images projected by the projector to improve a color distortion phenomenon, and calibrate the lenses of the projector to improve an image distortion phenomenon; and

Step 520: end.

In contrast to the prior art testing method for the display apparatus using the naked eye, measurement instrument, or an apparatus similiar to a digital camera, the present invention testing method for the display apparatus projects testing images on the display screen, and sends the testing images captured by the image capturing devices to the computer to allow the computer to analyze and process. By utilizing the characteristic of quick response of electric signals, the images captured from the sites needing to be judged are judged in a short time. Since the judgment criteria is standardized by computer programs, the uncertain time is shortened from more than six minutes, which the prior art image testing method for the display apparatus usually takes, to thirty seconds. The phenomena of image shift, image blurring, and dark corner are thus eliminated. Because the present invention testing method does not need to install lenses in the testing apparatus, all of the as-captured images are closer to original images, when the image capturing devices capture the images, to eliminate the phenomena of image distortion and color distortion. In contrast to the prior art method to utilize one image capturing device and one converting/transmitting interface for the image capturing device controlling signals, the present invention method utilizes the multitasking device to control a plurality of image capturing devices or a plurality of converting/transmitting interfaces for the image capturing device controlling signals. Therefore, the images of a plurality of testing sites are captured at the same time to reduce cost incurred from equipments and operation time. Since the multitasking device is connected to the computer, the switching action can be controlled by computer programs. Although when comparing with the prior art testing method for the display apparatus, whose capturing area varies when situation of lenses becomes different, the capturing area of the present invention testing method for the display apparatus is smaller, the resolution of the captured images according to the present invention is greatly improved due to no lenses effect.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for testing images displayed on a screen by a display apparatus, the method comprising:
installing a plurality of image capturing devices on the screen;
electrically connecting a computer to the image capturing devices;
capturing the images on the screen by utilizing the image capturing devices;
sending the images captured by the image capturing devices to the computer through the image capturing devices; and
processing the images captured by the image capturing devices by utilizing the computer.

2. The method of claim 1 further comprising electrically connecting the computer to the display apparatus to allow the computer to calibrate the display apparatus according to the images captured by the image capturing devices.

3. The method of claim 2 wherein the images captured by the image capturing devices are generated by projecting images on a projecting screen with a projector.

4. The method of claim 3 further comprising calibrating the alignment of the images projected by the projector according to the images captured by the image capturing devices with the computer so as to improve an image shift phenomenon.

5. The method of claim 3 further comprising calibrating the focusing of the images projected by the projector according to the images captured by the image capturing devices with the computer so as to improve an image blurring phenomenon.

6. The method claim 3 further comprising calibrating the brightness of some area of the images projected by the projector according to the images captured by the image capturing devices with the computer so as to improve a dark corner phenomenon.

7. The method of claim 3 further comprising calibrating the color blending of the images projected by the projector according to the images captured by the image capturing devices with the computer so as to improve a color distortion phenomenon.

8. The method of claim 3 further comprising calibrating the lenses of the projector according to the images captured by the image capturing devices with the computer so as to improve an image distortion phenomenon.

9. The method of claim 1 further comprising installing a plurality of color filters between the image and the image capturing devices to allow the image capturing devices to capture the image through the color filters.

10. The method of claim 1 further comprising electrically connecting a multitasking device between the image capturing devices and the computer to transmit the images captured by the image capturing devices to the computer through the multitasking device in sequence.

11. The method of claim 10 further comprising electrically connecting a converting/transmitting interface for the image capturing device controlling signals between the computer and the multitasking device to initialize the converting/transmitting interface for the image capturing device controlling signals according to the initialization signal generated by the computer.

12. The method of claim 10 further comprising respectively electrically connecting a converting/transmitting interface for the image capturing device controlling signals between the multitasking device and each image capturing device to initialize the converting/transmitting interface for the image capturing device controlling signals according to the initialization signal generated by the computer.

13. The method of claim 1 wherein the image capturing devices capture images on the screen.

14. The method of claim 13 wherein the image capturing devices are charge coupled devices (CCD).

15. The method of claim 13 wherein the image capturing devices are complementary metal-oxide semiconductor transistors (CMOS transistors).

16. An apparatus for testing images displayed on a screen by a display apparatus, the apparatus comprising:
a plurality of image capturing devices installed on the screen for capturing images on the screen; and
a computer electrically connecting to the image capturing devices for receiving the images captured by the image capturing devices and processing the images captured by the image capturing devices to calibrate the display apparatus.

17. The apparatus of claim 16 wherein the computer is electrically connected to the display apparatus to calibrate the display apparatus according to the images captured by the image capturing devices.

18. The apparatus of claim 16 wherein the images captured by the image capturing devices are generated by projecting images on a projecting screen with a projector.

19. The apparatus of claim 16 further comprising a plurality of color filters installed between the image and the image capturing devices to allow the image capturing devices to capture the image through the color filters.

20. The apparatus of claim 16 further comprising a multitasking device electrically connected between the image capturing devices and the computer to transmit the image captured by the image capturing devices to the computer in sequence.

21. The apparatus of claim 20 further comprising a converting/transmitting interface for the image capturing device controlling signals electrically connected between the computer and the multitasking device to execute initialization according to the initialization signal generated by the computer.

22. The apparatus of claim 20 further comprising a converting/transmitting interface for the image capturing device controlling signals electrically connected between the multitasking device and each image capturing device respectively to execute initialization according to the initialization signal generated by the computer.

23. The apparatus of claim 16 wherein the image capturing devices are used for capturing the images on the screen.

24. The method of claim 23 wherein the image capturing devices are charge coupled devices (CCD).

25. The method of claim 23 wherein the image capturing devices are complementary metal-oxide semiconductor transistors (CMOS transistors).
